(19) United States
(12) Patent Application Publication
(10) Pub. No.: US 2002/0169631 A1
(43) Pub. Date: Nov. 14, 2002

(54) System and method for providing employers with virtual interviews of potential job candidates

(76) Inventor: David M. Lewis, Calabasas, CA (US)

Correspondence Address: FULWIDER PATTON LEE & UTECHT, LLP, HOWARD HUGHES CENTER, 6060 CENTER DRIVE, TENTH FLOOR, LOS ANGELES, CA, 90045, US

(21) Appl. No.: 10/128,056

(22) Filed: Apr. 23, 2002

Related U.S. Application Data
(60) Provisional application No. 60/285,934, filed on Apr. 23, 2001.

(51) Int. Cl. G06F 17/60

(52) U.S. Cl. 705/1

(57) ABSTRACT

A system and method providing a central database of resumes including audio visual files of responses by an applicant to interview questions stored in a central database that may be searched by potential employers who may then review the stored resumes and stored audio-visual files. The stored audio-visual files thus displayed provide the potential employer with the opportunity to observe the demeanor of the applicant while the applicant responds to the interview question, thus providing a virtual interview.

### RELATED APPLICATIONS

This application claims benefit of priority to U.S. Provisional Application Serial No. 60/285,934, filed Apr. 23, 2001, the entireties of which are expressly incorporated herein by reference.

### BACKGROUND OF THE INVENTION

1. Field of the Invention

The present invention relates generally to computerized systems and methods for providing searchable databases containing information about job applicants to potential employers for use in pre-screening applicant resumes or qualifications. More particularly, the present invention relates to a system and method for providing a searchable database containing job applicant resumes and links to audio-visual files containing recordings of questions and answers recorded during an interview of the applicants.

2. Description of Related Art

Use of the Internet for job searching has recently become popular. A myriad of web sites such as Monster.com and others are presently active. While these sites provide useful information about persons seeking employment, and allow potential employers to search a database of job seekers, these web sites in reality do little more than provide the same information traditionally available on a job seekers' resume. The primary advance in using the web-based sites at this time appears to be limited to making it easier for a job seeker to get his resume in front of a wider audience of potential employers without incurring the cost of mailing or personal distribution.

While use of the Internet aides a job seeker in presenting his resume to a wider universe of potential employers, it does little to assist the potential employer in finding the right person for an open position. Web sites typically allow potential employers to search through a database of job seekers. Such a search typically returns responses, or “hits,” for persons who, for one reason or another, use particular key words or other search terms in their resume that cause the search engine to list them in the search results. Unfortunately, many of these “hits” are, in reality, job seekers who are either not qualified or not interested in the particular kind of work that a potential employer may have to offer.

Moreover, even where appropriate candidates are identified, potential employers still have no more information than is available from a traditional resume, and must contact each individual candidate and spend valuable time interviewing them. Unfortunately, many of the identified candidates are technically deficient, lack interpersonal communication skills, or are otherwise inappropriate candidates for the work being offered. These facts are usually only discovered after the potential employer meets with the job-seeker during a time consuming and expensive interview.

### SUMMARY

In use, the system and method of the present invention is embodied in a web site which is accessible by potential employers who can log onto the web site through the Internet. The system of the present invention includes a central server operably connected with a storage media for storing a database containing job seeker information, including stored audio-visual files containing questions and answers recorded during an interview of the job seeker. The server may also be connected to appropriate input and output hardware, such as scanners, printers and the like, as well as having an operable connection to other devices such as video cameras or other recording devices. The server also includes communication technology allowing the server to be connected to the Internet. The web site of the present invention is established on the server using software well known in the art. Additionally, the web site may include proprietary software written for the specific application embodying the present invention.

In one embodiment, the present invention includes a method for providing a potential employer using a server system having a server accessible by the potential employer via a communication link with information about a job applicant, the server system including program software for communicating with the potential employer and for processing input received from the potential employer to instruct programs running on the server system to display information to the potential employer, the method comprising searching a database of information stored in a memory of the server system, the database containing information provided by job applicants, displaying a list of job applicants having characteristics that match search criteria provided by the potential employer, selecting from the list of applicants to display information entered by the job applicant to the potential employer, the information forming a resume of the selected job applicant, providing links on the selected resume to audio-visual files including stored responses to selected questions asked of the selected job applicant at an interview; and displaying the contents of a selected audio-visual file to the potential employer.

In another embodiment, the present invention includes providing a subsystem accessible by potential job applicants, including providing at least one question to the potential job applicant related to the applicant's education, skills or experience, recording the applicant's answer to the at least one question; and storing the recorded answer in the searchable database. In yet another embodiment, the recorded answer is stored as an audio-visual file.

Other features and advantages of the present invention will become apparent from the following detailed description, taken in conjunction with the accompanying drawings which illustrate, by way of example, the principles of the invention.

### BRIEF DESCRIPTION OF THE DRAWINGS

FIG. 1 is a block diagram illustrating an overview of the arrangement of subsystems of the system of the present invention.

FIG. 2 is a block diagram illustrating a subsystem for use by a potential employer embodying the principles of the system of FIG. 1.

FIG. 3 is a exemplar of one embodiment of a web page incorporating subsystems that may be accessed by a user of the system of FIG. 1.

FIG. 4 is a block diagram of various subsystems accessible through the client home page subsystem of the system of the system of FIG. 1.

FIG. 5 is an example of one embodiment of a web page that is displayed by the system of FIG. 1.

FIG. 6 is an example of one embodiment of a web page showing an arrangement of resume information and hyperlinks allowing a potential employer to access audio-visual files containing responses to questions posed during a virtual interview of an applicant.

### DETAILED DESCRIPTION OF THE PREFERRED EMBODIMENT

The present invention provides a method and system for providing resumes incorporating virtual interviews of potential job candidates that may be reviewed companies or individuals with jobs to offer. The database of resumes, including audio-visual files of the virtual interviews are stored on a computer or server that is accessible using a communication link, such as the internet, dial-up connection, or other means. Access to the database may be restricted to companies or individuals seeking to employ workers who have registered with the operators of the interview system and who access the system using unique passwords or other means designed to ensure that only clients of the system may access the system.

The system may also be accessed by potential job applicants or candidates in a manner similar to that described above. For example, an applicant may attempt to access the system using an internet connection, a dial-up connection, or other such means. Once connected, the applicant may access various web pages, windows or other means to access programs embodied in software running on the server or computer that allow the potential applicant or job candidate to register as an applicant with the system and to submit a resume which will be stored on the system in a searchable database. A particularly advantageous aspect of the system in accordance with the present invention is the ability for a job seeker to initiate software running on the server that allows the job seeker to respond to questions interactively posed to him or her by the system. The questions and the applicant's responses are then assembled by the system in the form of a virtual interview that is associated with the applicant's resume and stored in the searchable database where it may be accessed, as described in more detail below, by employers using the system to search for candidates for open employment positions.

Alternatively, and even more advantageously, the applicant or job candidate may receive an instruction from the system to upload a video of a potential interview in which the applicant has been recorded answering questions posed to them by the system or by a live interviewer. In the later example, the system may provide a message to the applicant providing information, such as location and an appointment time and date, where the applicant may to go to the location identified the system where an interview of the applicant will be undertaken. This interview may either take the form of the potential job seeker responding to questions posed to the potential job seeker on a computer screen by the system, or, alternatively, the questions may be asked by a human interviewer. In either case, the interview may be recorded as an audio-visual file and then stored in the searchable database of the system. where it may be associated with the potential job seekers resume, and accessed by clients of the system who are searching for applicants to fill open job positions.

Users of the system, whether job applicants or potential employers, may access the information stored on the system's servers or computers from a terminal or computer located either in office, home, or other location providing access to the system. The computers through which the system is accessed typically run appropriate application software, such as Microsoft Windows published by Microsoft, Inc., an appropriate web browser software, such as Microsoft Internet Explorer published by Microsoft, Inc. or Netscape Navigator published by Netscape, Inc.

In a typical embodiment, a user communicates with the central server of the system by connecting to the internet either directly through a local or wide area network or via modem, cable modem, digital subscriber line, or other communication means. Typically, such a connection will be established using a secure communication protocol, such as secure socket layer (SSL) protocol. Such a protocol usually provides for encryption of the data stream such that even if the data stream is intercepted as it is transmitted between the user's computer and the system's server, the confidentiality of the data stream is maintained. Alternatively, access to the system may be established using a non-secure communication protocol.

Once a connection has been established between the user's computer or terminal and the system's central server, data may flow in both directions from the user's computer or terminal to the system's server and from the system's server back to the user's computer or terminal.

In one embodiment of the present invention, a job seeker who has submitted a virtual resume to the system's central server may also be able to access the server to edit their resume in the event that information in the resume becomes stale or requires change for some reason. Security measures that are well-known in art are used to protect the integrity of the central database to prevent an applicant's data from being accessed by another applicant or other unauthorized user of the system. In this manner, the confidential nature of any private or proprietary information of the applicant's resume and virtual interview is secured.

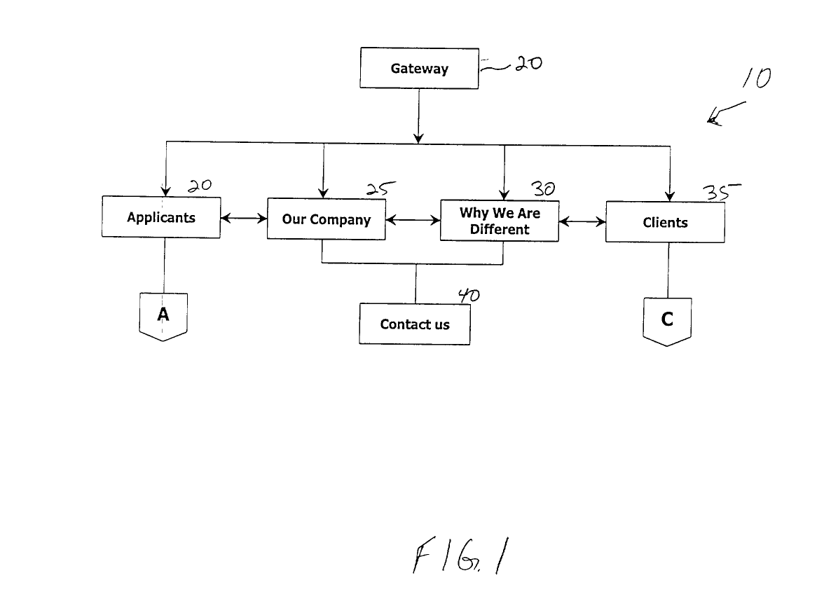

An overview of the present invention is depicted in the exemplary illustration of FIG. 1. In one embodiment of the present invention illustrated by system 10 of FIG. 1, users of the system access the system through a gateway 20. As described previously, this gateway may be a web server running software designed to facilitate communication between the web server and users of the system who connect to the web server through the internet or other means. The software may also facilitate the receipt and transmission of data to the user from the system and similarly from the user to the system. For example, the server may communicate data which is used by a remote user's computer to display web pages containing various information or forms to be filled out by the remote user. The remote user may interact with aspects of the web pages displayed on his or her computer to, in turn, provide information in the form of data communicated by the user's computer back to the system's server that is then stored in a central database associated with the server. In this manner, users accessing the system of the present invention through gateway 20 may access the system to query the system's database or other subsystems and receive information in response to those queries from various aspects or subsystems of system 10.

Once a user has accessed system 10 through gateway 20, the user may be presented with a web page having various icons and text displayed thereon. In the example illustrated in FIG. 1, such a web page may have icons, links or other identifying indicators which may be activated by a user to access various subsystems of the system. For example, there may be a subsystem 20 designed for use by potential job applicants, a subsystem 25 designed to provide information about the system, a subsystem 30 for providing a user with an explanation of how the system of the present invention differs from other systems or web pages containing lists of applicant resumes, and a subsystem 35 for use by clients of the system who have submitted jobs that need to be filled. Additionally, the web page may provide an icon, link or other indicator that allows access to a subsystem 40 that enables a user to contact the operators of the system, such as by providing an email address or telephone number.

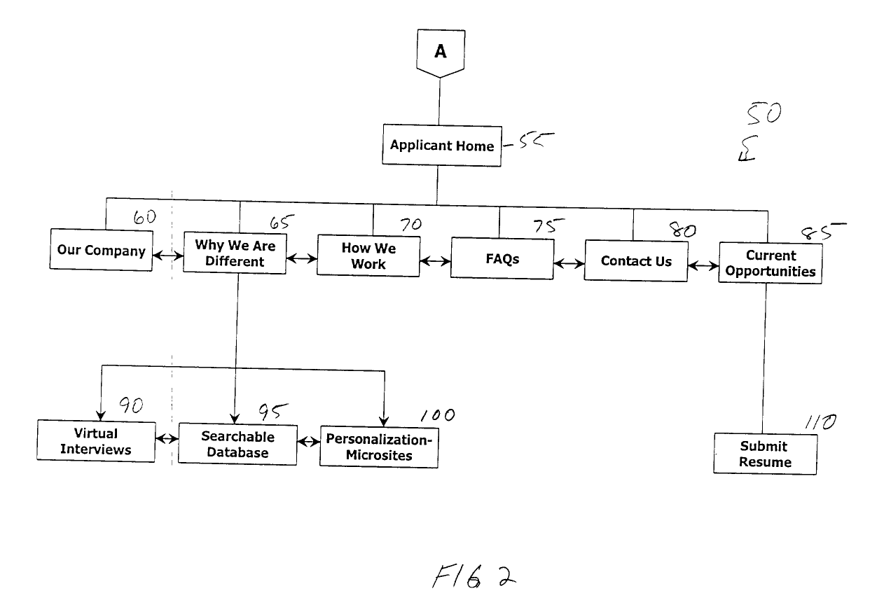

Referring now to FIG. 2, various aspects of the subsystem 20 (FIG. 1) embodied in a subsystem 50 designed an applicant with web pages having links to various other subsystems for collecting information from the applicant or for providing information to the applicant, including access to systems for accepting data to be included in a virtual resume to be stored in the central base of the system is described. An applicant logs into the system as described previously, and accesses subsystem 50 by clicking on an icon or link that displays a web page, tilted, for example, applicant home page 55. Upon accessing the applicant home page 55, the applicant may be presented with a web page containing, for example, and not limited to, a variety of icons, links or other indicators that, upon actuation by the applicant, allows the applicant to be directed to other web pages designed to provide specific information to or to query information from the applicant.

For example, in one embodiment, the applicant home page may allow access to a subsystem 60 that provides information about the services offered by the operator of the system, as well as a subsystem 65 that provides information distinguishing the services offered by the operator of the system from other job bulletin boards, such as those offered by Monster.com. The applicant may also access subsystem 70 which describes how the system works, as well as subsystem 75 that may consist of a series of frequently asked questions, or FAQs, that provide information to the applicant about use of the system. As before, the applicant may also be provided with a subsystem 80 which provides information and methods for contacting the operation of the system. It will be understood by those skilled in the art that activation of a subsystem by clicking on an icon or link to the subsystem causes the subsystem to activate and display various pages of information or forms to the user. These pages may also include links to other subsystems, providing a complex system having many features and capabilities but which is also easy to navigate.

Subsystem 85 provides access to the searchable database contained in the system that allows an applicant to search a list of current opportunities to see if there are any opportunities that may match the skills of the applicant and also the type of job that applicant is seeking. Should the applicant decide that one or more of the opportunities available through subsystem 85 are interesting, the applicant may decide to submit a resume to the system by clicking on the icon or link that activates the software program or programs of subsystem 110.

Also shown in FIG. 2 are subsystems 90, 95, and 100, which are shown to be accessible through subsystem 65. While these systems are depicted as being accessible from subsystem 65, they may also be accessed through any of the other subsystems, such as subsystem 60, 70, 75, 80, and 85. For example, an applicant accessing the current opportunities subsystem 85 may access subsystem 95 which allows the database to be searched. The application may also access a subsystem 100 which allows access to personalized or individualized micro web sites that provide information about potential job offers. For example, such micro sites may contain information such as location, number of employees, salary ranges, benefits offered, and particular positions open for which the potential employer is accepting applications. Moreover, the various subsystems may provide access to subsystem 90, which is a subsystem devoted to obtaining information from the applicant that may then be incorporated into a virtual interview which is associated with the applicant's resume and stored in the searchable database on the central server.

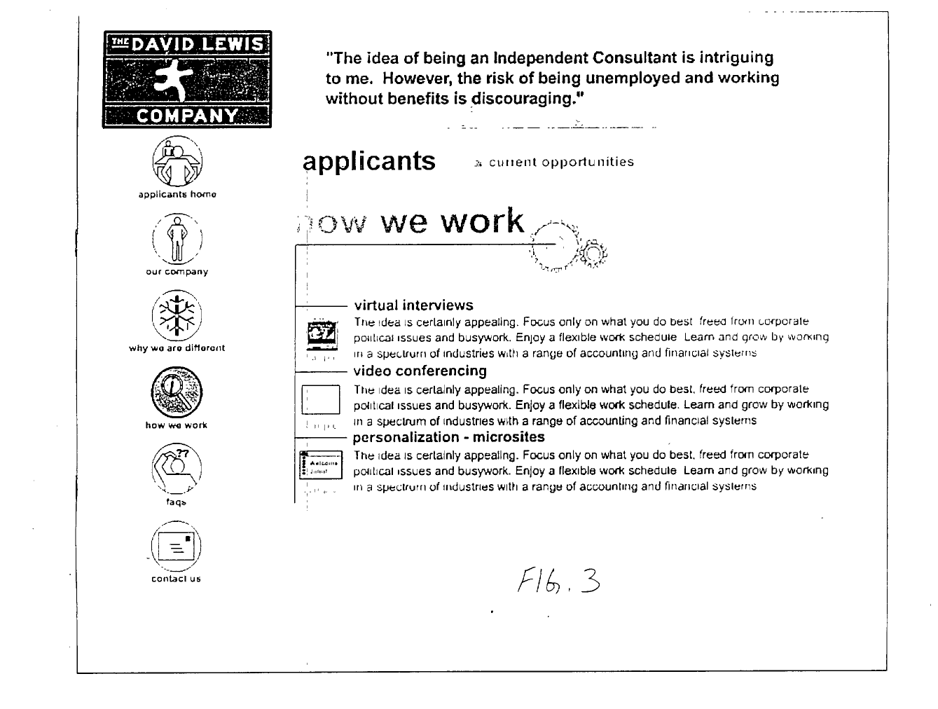

FIG. 3 is an illustrative embodiment depicting a web page that may be displayed to an applicant. As can be seen in FIG. 3, the applicant is presented with various icons or links that, when clicked by an applicant using a mouse or other pointing device, activate or provide access to various subsystems as described above.

One particularly advantageous aspect of the present invention is the inclusion of virtual interviews associated with the applicant's resume in the database that may be searched by potential employers. Several different methods may be employed to provide audio-visual information, including video footage of the virtual interview, to the system for storage in the searchable database of the system. For example, where the applicant's computer is equipped with a video camera, such as the well-known web cam device or other video camera, the applicant may interact with a questionnaire presented to him by the system and displayed on his terminal or computer and use the video camera to record his answers to the question in a file that may be then submitted, in real time, to the system's server for storage in the searchable database. Alternatively, the applicant may prerecord an audio-visual file of the applicant answering questions posed by a questionnaire which may be either displayed on the applicant's computer, or which may be printed by the applicant on a printer for use away from his computer. The pre-recorded audio-visual file may then be communicated from the user's computer to the central system for storage in the database after editing. In still another embodiment, the applicant or candidate may go to a location identified by the system where the interview may be performed and recorded. In this embodiment, the candidate or applicant may be presented with a list of questions displayed on a monitor, or the questions may be asked by a live interviewer. Additionally, the list of questions presented to the candidate, whether displayed to the candidate in real time on his computer screen, on a computer screen at an interview site, or asked by an interviewer, may be a list of generalized questions asked to every candidate or applicant, or the questions may be selected from a list of questions, the selection being a function of a determination made in response to an applicant's responses to questions regarding certain criteria, such as, for example, type of job sought, educational background or experience level.

The candidate's information is then stored in the database, along with the responses to the questions posed to the candidates. These responses may either be stored in a record along with the candidate's other information, or, using hyperlink methods well-known in the art of web site design and programming are stored in other files where they can be easily accessed with a mouse-click or a key command. Each answer or response is recorded with standard video equipment, converted to a file having an appropriate file format, such as AVI, MPEG or digital tape, and then compressed for display using, for example, Windows Media by Microsoft Inc., Real Player by RealNetworks, Inc. and Quicktime by Apple, Computer, Inc.

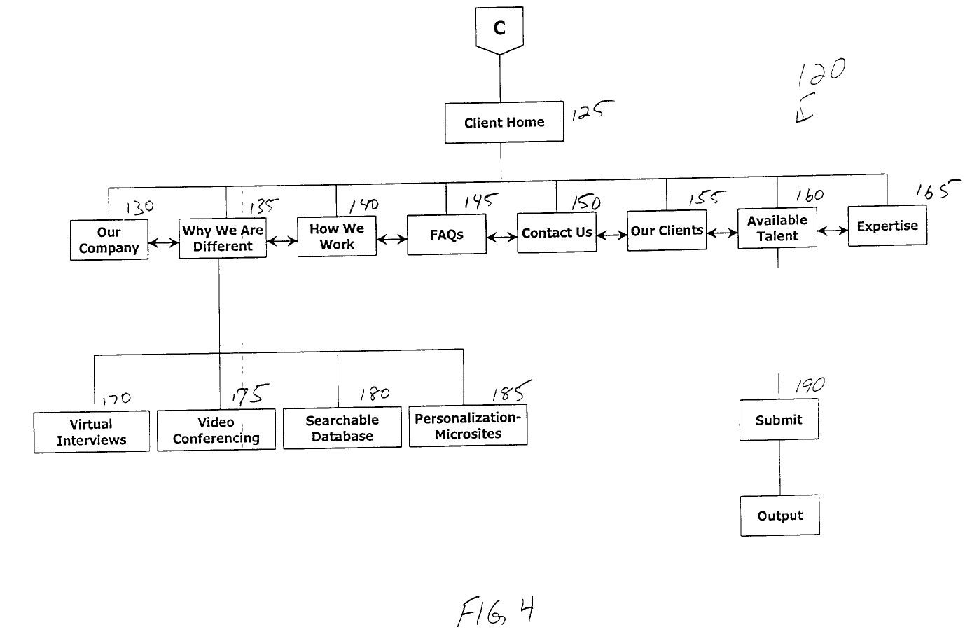

FIG. 4 depicts and exemplary embodiment of the subsystem 120 accessible through the system's server that is dedicated to serving the requirements of a potential employer who is a client of the system. When a potential employer or client registered with the system accesses subsystem 120 through gateway 20 (FIG. 1), the client or employer logs into the system if an account for the client or employer has been established with the system. If the potential employer is a new user of the system and does not have an account, the employer is instructed to sign up with the system to gain access to the services available on the web site. The system provides various pages where the employer may enter information necessary to register the employer and open an account for the employer on the system. Once log in or registration is completed, the potential employer is provided with access to the various services offered by the system.

Various subsystems are available to the potential employer, such as subsystems 130 and 135 which again, as described previously, may provide information about the system as well as distinguish the services of the system from other job offering systems. Additionally, a subsystem 140 describing the way the system works, as well as a frequently asked question subsystem 145 may be provided. Subsystem 150 may provide access to a mailing system or provide a phone number and address for contacting the operators of the system. Subsystem 120 may also include a subsystem 155 wherein a potential employer may search a list of other clients of the system. Subsystems 160 provides access to a list of applicants )whose resumes and virtual interviews are stored in the searchable database. Subsystem 160 may also provide access through icons or links to subsystem 165, which provides access to a listing of the expertise of various applicants, subsystem 170 which provides access to the database containing virtual interviews of applicants, subsystem 175 which activates software to provide for video conferencing between applicants and the potential employer, subsystem 180 which provides access to a searchable database of applicants, as well as subsystem 185 which may provide access to personalized or individualized micro web sites set up by applicants to provide information about themselves. While subsystems 170, 175, 180, and 185 are depicted as being accessed through subsystem 135, those skilled in the art will immediately understand that subsystems 170, 175, 180, and 185 may also be accessed through any of the other subsystems, such as subsystems 155, 160, or 165, as determined by the operator of the system to provide the most efficient access to information of greatest use to potential employers.

An employer may search the list of available applicants by activating the appropriate subsystem which will present the employer with the opportunity to select search terms or other criteria from lists of criteria, depending on the needs of the employer and the particular skills, education or experience the employer is seeking. Once the employer has searched the list of available applicants, the employer may select from list of applicants that is displayed or printed for his review. In some cases, the employer may require additional information about an applicant, and may query the system to determine if the system has any additional information about that applicant.

For example, employers may use subsystem 190 to either request additional information about particular applicants and instruct the system to activate subsystem 200 which may provide output containing various information as well as responses to the virtual interview about selected applicants, or alternatively, subsystem 190 may be activated to provide a facility for the potential employer for indicating while he is online with the system that he would like to hire a particular applicant. Subsystem 190 may provide a facility for contacting a selected applicant, either to set up a further interview, or to send a message, which may be either an email message or a preprinted letter to the applicant indicating that the potential employer would like to offer the applicant either a further interview or a position with the potential employer.

Additionally, the employer may select a link or icon associated with a selected applicant or candidate by clicking on the icon or link that is displayed on the list of search results. Clicking on the selected link or icon causes a page to be displayed on the user's computer that contains the selected applicant's resume and virtual interview responses. Alternatively, the page may display links to individual questions and responses by the applicant recorded during the course of his or her virtual interview.

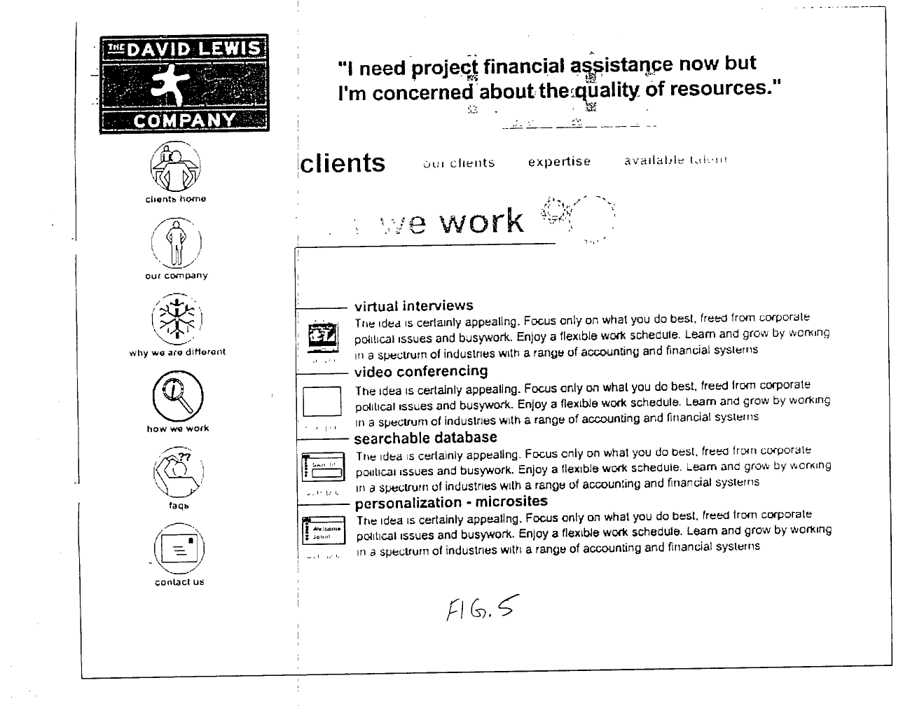

FIG. 5 depicts an exemplary web page that is displayed to a client after the client (potential employer) logs onto the system and activates the clients subsystem 35 (FIG. 1). As depicted, a client may activate various subsystems, including subsystems providing access to a database of virtual interviews, establishing video conferencing between clients and potential candidates or applicants, access to the searchable database of resumes, or access to personalized micro web sites set up by applicants or other clients of the system to provide additional information about the client or applicant than is typically stored in the searchable database.

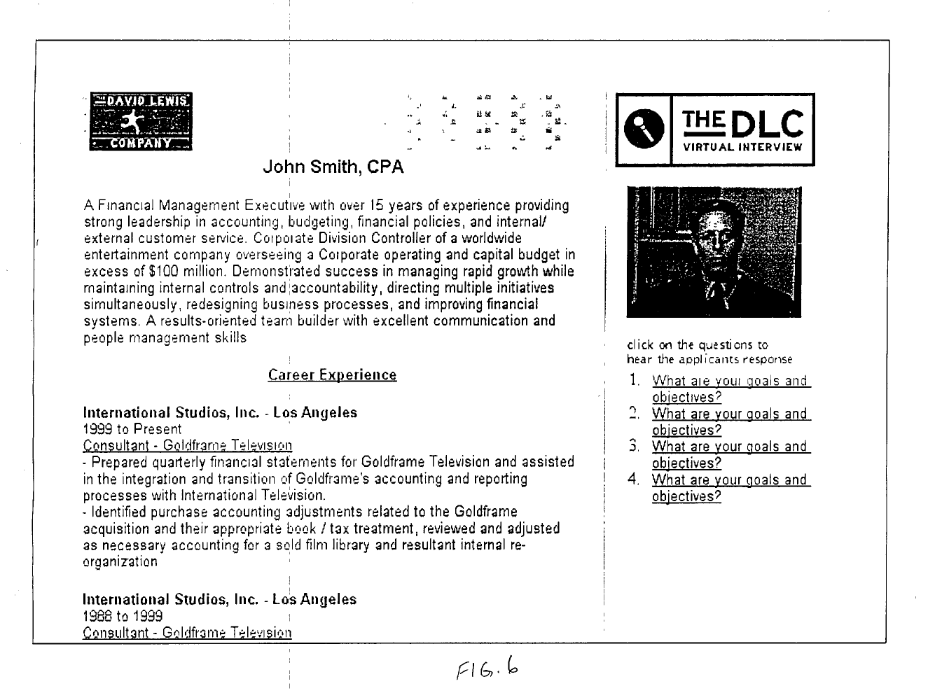

FIG. 6 depicts one embodiment of a web page that is displayed by the system of the present invention incorporating resume information as well as links to answers recorded during an interview session and which are stored in the searchable database of the system. As illustrated by FIG. 6, the virtual interview section displayed on the web page may be structured so that the potential employer may review the resume of a candidate on-line to find those candidates whose job history and credentials appear to meet the requirements of the potential employer. Unlike other web-based job employment systems, the embodiment of the present invention depicted in FIG. 6 goes further and includes the ability to play back questions and responses by the candidate that were stored in audio-visual files available by clicking on links associated with individual questions. Clicking on a link causes software running on the server to transmit information contained in the audio-visual file to the employer's computer where the contents of the audio-visual file are displayed for the employer's review.

As illustrated in FIG. 6, a potential employer may choose from a list of questions that were posed to a applicant or candidate for replay by clicking on an appropriate link. Upon clicking on the link to the selected question, a new window may open on the potential employer's computer, and the question and answer by the candidate are replayed. In this way, the potential employer has the opportunity to both see the candidate while he is answering the questions and to evaluate the candidate's interpersonal skills. Moreover the demeanor and content of a response to a particular question may provide the potential employer with information for evaluating the suitability of the candidate.

Alternatively, the employer may be given the option to view the entire stored virtual interview. The play back window may incorporate links, icons or other devices that may be activated with a mouse-click to control the play back of the virtual interview. Such controls may include buttons or other icons that, when activated, will cause the virtual interview to pause, stop, rewind, fast forward and play.

After having viewed the audio-visual presentations associated with each of the candidate's or applicant's resumes, the potential employer is interested in, the potential employer then uses this information to select candidates for either employment or further interview. Using the system and method of the present invention, a potential employer may thus retrieve far more information about a candidate or applicant than would otherwise be available from prior art web-based resume services.

The system and method of the present invention thus improves the ability of the potential employer to search for suitable candidates by allowing a prescreening evaluation of candidates where resumes appear interesting, but, after further evaluation of their virtual interview responses, may not be suitable for the position offered by the employers. A potential employer need only invest the time and expense of a traditional interview in those candidates who the potential employer feels are likely to be suitable, based upon their responses in the virtual interview process. The system and method of the present invention is equally applicable to searches for full-time or part-time employees. The present invention also applies to searches for temporary employees, where the agency provides virtual interviews of full- or part-time employees for the potential employer to search, allowing the employer to select among the temporary employees who best fit the employer's needs. Thus, the system and the method of the present invention improves the job search process and substantially decreases the probability that a potential employer will waste time and expense on interviewing unsuitable candidates.

While several particular forms of the invention have been illustrated and described, it will also be apparent that various modifications can be made without departing from the spirit and scope of the invention. Accordingly, it is not intended that the invention be limited except as by the appended claims.

I claim:

1. A method for providing a potential employer with information about a job applicant,
providing a server system having a server accessible by the potential employer via a communication link, the server system including program software for communicating with the potential employer and for processing input received from the potential employer to instruct programs running on the server system to display information to the potential employer, the method comprising:
searching a database of information stored in a memory of the server system, the database containing information provided by job applicants;
displaying a list of job applicants having characteristics that match search criteria provided by the potential employer;
selecting from the list of applicants to display information entered by the job applicant to the potential employer, the information forming a resume of the selected job applicant;
providing links on the selected resume to audio-visual files including stored responses to selected questions asked of the selected job applicant at an interview; and
displaying the contents of a selected audio-visual file to the potential employer.

2. The method of claim 2, wherein providing a server system includes providing a subsystem accessible by potential job applicants, including:
providing at least one question to the potential job applicant related to the applicant's education, skills or experience;
recording the applicant's answer to the at least one question; and
storing the recorded answer in the searchable database.

3. The method of claim 2, wherein the recorded answer is stored as an audio-visual file.
